(19) United States
(12) Patent Application Publication
(10) Pub. No.: US 2006/0121317 A1
(43) Pub. Date: Jun. 8, 2006

(54) Magnetic recording medium, method of manufacturing the magnetic recording medium and a magnetic disk drive using the magnetic recording medium

(75) Inventors: Yuichi Kokaku, Kanagawa (JP); Mitsuhiro Shoda, Kanagawa (JP); Hiroyuki Matsumoto, Kanagawa (JP); Mikio Suzuki, Kanagawa (JP); Takehiko Hamaguchi, Kanagawa (JP); Yuzuru Hosoe, Tokyo (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/288,546

(22) Filed: Nov. 28, 2005

(30) Foreign Application Priority Data
Dec. 7, 2004 (JP) 2004-353985

(51) Int. Cl. B05D 5/12

(52) U.S. Cl. 428/826; 427/127

(57) ABSTRACT

The present invention restricts defect density on the magnetic disk based on predetermined polishing conditions by applying a magnetic field to the entire surface of a magnetic disk in a direction vertical thereto, rotating the magnetic disk, loading a magnetic head to the magnetic disk, reproducing signals from the magnetic disk, processing the reproduced signals by a waveform analyzer, counting pulse waveforms of 0.9 times or more a servo-bit length at ½ threshold value of an average output, and measuring the defect density on the magnetic disk giving an undesired effect on the I/O performance of the magnetic disk drive. In a case of a magnetic recording medium using a vertical magnetic recording system, even with fine defect of magnetic layer, a servo pattern cannot be judged correctly. This provides degradation of the I/O performance of increasing the time necessary for reading out large capacity data, lowering the performance of the entire magnetic disk drive.

### CROSS-REFERENCES TO RELATED APPLICATIONS

This application claims priority from Japanese Patent Application No. JP2004-353985, filed Dec. 7, 2004, the entire disclosure of which is incorporated herein by reference.

### BACKGROUND OF THE INVENTION

The present invention relates to a magnetic recording medium, a method of manufacturing the magnetic recording medium and a magnetic disk drive using the magnetic recording medium.

A magnetic disk drive is a device for moving a magnetic head relative to a rotating magnetic disk in the radial direction of the magnetic disk thereby magnetically writing and reading data at a predetermined radial position. The magnetic disk drive includes one or a plurality of magnetic disks, a spindle motor for rotating the magnetic disks, a magnetic head corresponding to each of the surfaces of the magnetic disks, a driving mechanism for the magnetic head, a signal processing mechanism, electric circuit components and interface sections for transferring signals between the magnetic disk drive and external equipment, which are mounted in a casing thereof.

In recent years, magnetic disk drives small in size and large in capacity are utilized in not only personal computers but also electric products for home use and increased capacity and improved recording density have been strongly demanded for such magnetic storage units. Accordingly, application of the so-called vertical magnetic recording system to the magnetic disk drives has been studied instead of the existent horizontal recording system. The vertical magnetic recording system is one in which recording and reading is performed by a vertical magnetic field. It has then been conducted competitively to put the same into practical use.

The vertical magnetic recording system has a potential of less disturbance of recording between adjacent bits as in the existent horizontal recording system and capable of increasing the recording density. For example, in the vertical magnetic recording system, magnetization in recording-magnetic domains adjacent to each other in a magnetic recording medium is perpendicular to the film surface and anti-parallel with each other. Accordingly, it is considered that the magnetized state recorded at high density is stable in view of energy and the vertical magnetic recording system is essentially suitable to high-density recording.

On the other hand, the combination of a single pole recording magnetic head and a two-layered magnetic recording medium having a soft magnetic under layer can improve the recording efficiency and cope with the increase in the coercivity of the recording film. However, to attain high-density recording by using the vertical magnetic recording system, it is necessary to develop a vertical magnetic recording medium with less noise and resistance to thermal demagnetization. As a vertical magnetic recording medium for attaining the same, a vertical magnetic recording medium having a granular type recording layer with the addition of an oxide to a CoCrPt alloy has been studied. For example, a technique is disclosed in Japanese Patent Laid-open No. 2003-178413.

Further, the soft magnetic under layer used for the two-layered vertical medium is generally formed of a soft magnetic material of high saturation magnetic flux density (Bs) to improve the recording efficiency. In a case where a magnetic wall is present in the soft magnetic under layer, therefore, magnetic fluxes are leaked greatly therefrom. In addition, when the magnetic head passes thereabove, spike-shaped noise is superimposed on reproduced signals to deteriorate the signal quality. To solve such a problem, a technique is known for suppressing the movement of the magnetic wall in the soft magnetic under layer by exchange coupling with the anti-ferromagnetic layer. For example, a technique disclosed in Japanese Patent Laid-open No. 6-103553 can be mentioned. Further, there is a technique of constituting a soft magnetic under layer with two or more soft magnetic layers formed by separating the soft magnetic under layer with a non-magnetic layer and inverting the direction of the magnetization in the soft magnetic layer. For example, there is a technique as disclosed in Japanese Patent Laid-open No. 2001-331920.

### BRIEF SUMMARY OF THE INVENTION

A vertical recording system magnetic disk drive may be manufactured by using a two-layered vertical medium comprising a granular-type recording layer with the addition of oxide to a CoCrPt series alloy and a soft magnetic under layer. In this case, however, while an S/N ratio equal substantially to that of an existent in-plane magnetic recording medium is obtained by spin stand evaluation, degradation of I/O performance is observed in which a time required for reading out a large capacity data increases. This produces a problem in that no sufficient performance can be obtained for the magnetic disk drive. As a result of analysis, it has been found that the problem is caused by the reasons to be described hereinbelow.

Generally, one of the causes for the noise is due to magnetic defects present in the magnetic disk. For example, loss, indent and deposits of the magnetic layer may possibly cause errors. However, in a case where they are present in a data region, normal reading and writing can be conducted by a system called an error correction code by providing a retardant bit. That is, it is designed so as to endure the use with no fatal error up to a certain number of errors.

On the other hand, to write and read data in a magnetic disk drive, it is necessary to follow a predetermined data track. Accordingly, a technique of previously recording a special pattern referred to as a servo pattern is often used. The servo pattern is recorded in a region different from the data region. Since the servo pattern is written before shipping of products and is not re-written after shipping, when the pattern is destructed, the magnetic disk drive can no more be driven.

Usually, a track that cannot be distinguished normally upon formatting of a magnetic disk drive is recorded as an abnormal track. A magnetic head does not access the recorded abnormal track for reading but an alternative track is provided for processing. However, since the number of substitution tracks is limited, if the limit is exceeded, the magnetic disk drive can no longer operate normally. In usual in-plane recording, the servo pattern is significantly larger as compared with the data bit and the occupation area is also small. Accordingly, the frequency in which a huge defect happens to encounter the servo pattern is low and causes no significant problem except for considerably higher error density. This is because the fluctuation of the recording magnetic field is small in a case where the defect is small and does not exceed the threshold value for the judgment of the servo pattern thereby causing no problem.

However, in a case of a magnetic recording medium using a vertical magnetic recording system, the servo pattern cannot be distinguished correctly even with a fine magnetic layer defect. This degrades the I/O performance, that is, the time necessary for reading the large capacity data is increased. This lowers the performance of the entire magnetic disk drive.

In order to solve the foregoing problem, it is necessary to restrict a magnetic defect to a certain level or less in a magnetic disk drive comprising a vertical magnetic recording medium on which tracks having servo regions are formed and a magnetic head of a vertical magnetic recording. However, it is difficult to completely avoid extremely small defects in the course of manufacturing the magnetic recording media. Therefore, mere definition for the defect density of the magnetic recording medium is not practical since this only lowers the yield in view of manufacture.

The present invention provides a magnetic disk drive using a vertical magnetic recording system, having a large capacity and excellent I/O performance. Further, the invention provides a magnetic recording medium suitable to a magnetic disk drive using a vertical magnetic recording system, having large capacity and excellent I/O performance, as well as a manufacturing method thereof.

The present invention restricts defect density on a magnetic disk based on predetermined polishing conditions by applying a magnetic field to the entire surface of a magnetic disk in a direction vertical thereto, rotating the magnetic disk, loading a magnetic head to the magnetic disk, reproducing signals from the magnetic disk, processing the reproduced signals by a waveform analyzer, counting pulse waveforms of 0.9 times or more a servo-bit length at ½ threshold value of an average output, and measuring the defect density on the magnetic disk giving an undesired effect on the I/O performance of the magnetic disk drive.

According to the invention, the data reading time (data transfer time) of the magnetic disk drive using the vertical magnetic recording medium can be shortened to enhance the I/O performance.

### BRIEF DESCRIPTION OF THE DRAWINGS

FIG. 1 shows an example of a defect in a recording layer present on a magnetic recording medium.

FIG. 2 shows an example of a signal measured in the magnetic recording medium shown in FIG. 1.

FIG. 3 shows a comparative example of signal measurement in a case where the defect shown in FIG. 1 was present in each of the magnetic recording medium using an in-plane magnetic recording system and a magnetic recording medium using a vertical magnetic recording system.

FIG. 4 shows a relationship between the size of a defect and the probability for the occurrence of bit error in a servo region when vertical magnetic recording media having various magnetic defects are incorporated in a magnetic disk drive.

FIG. 5 shows a relationship between the density of defects having a length 0.9 times or more the servo bit length and the data transfer type in a magnetic disk drive.

### DETAILED DESCRIPTION OF THE INVENTION

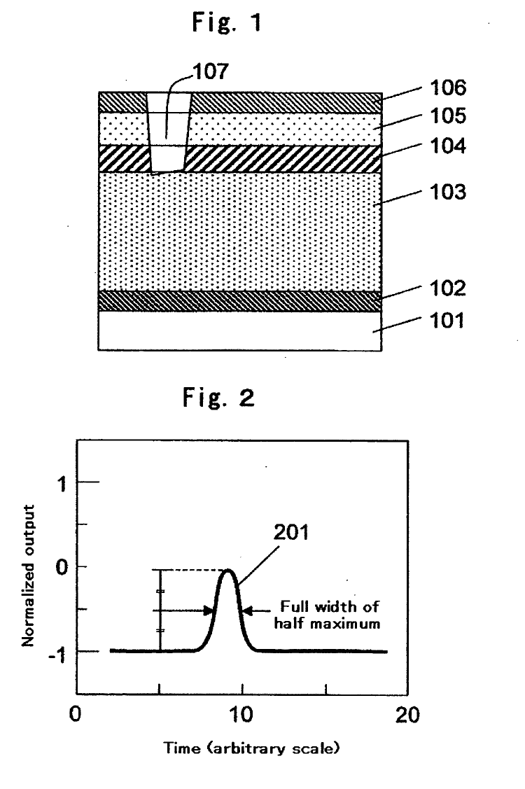

FIG. 1 shows an example of a defect in a recording layer present over a magnetic recording medium 1. FIG. 2 shows an example for the observation of a signal in the magnetic recording medium shown in FIG. 1.

The magnetic recording medium in FIG. 1 comprises a substrate 101, an adhesion layer 102, a soft magnetic under layer 103, an intermediate layer 104, a recording layer 105 and a protective layer 106. The recording layer 105 contains a defect 107. The depth of the defect 107 reaches a boundary between the soft magnetic under layer 103 and the intermediate layer 104 and the recording layer at the portion completely is lacked. If such a defect is present on the magnetic recording medium, not only a desired pattern cannot be recorded to the portion but also a pulse-like output 201 is observed as shown in FIG. 2 even in a case where a magnetization transition pattern is not recorded in the portion (in a case of magnetizing the magnetic recording medium in one direction by the magnetic head). In particular, if such a defect is present in a servo pattern as a servo signal recording portion, erroneous recognition for address information contained in the servo signal or degradation of the servo signal quality is generated to deteriorate the I/O performance of the magnetic disk drive.

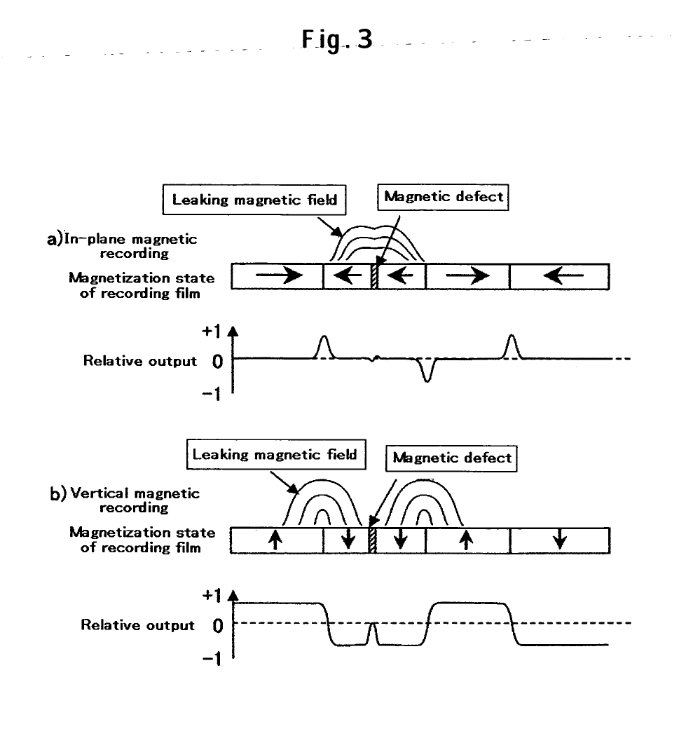

FIG. 3 shows a comparative example of signal observation in a case where the magnetic recording medium using the in-plane magnetic recording system and a signal recording medium using a vertical signal recording system each contain a defect as shown in FIG. 1.

As shown in FIG. 3(a) in a magnetic recording medium using the in-plane magnetic recording system (hereinafter referred to as an in-plane magnetic recording medium), since the magnetic fluxes or lines just above the defect portion is not reduced to zero even when it is weakened, it can be seen that this forms noise but is less recognized erroneously as a bit. On the other hand, as shown in FIG. 3(b), in a magnetic recording medium using the vertical magnetic recording system (hereinafter referred to as vertical magnetic recording medium), the magnetic field is reduced to zero just above the defect portion and tends to be recognized erroneously by the magnetic head as the end of the servo pattern bit.

The magnetic defect leading to the erroneous recognition of the servo pattern gives an effect as error in a case where the radial size thereof exceeds the width of the reading track of the magnetic head and the defect is contained in the servo region. Further, in the running direction of the magnetic head, a magnetic defect with a certain length or more determined by the servo signal system also gives an effect.

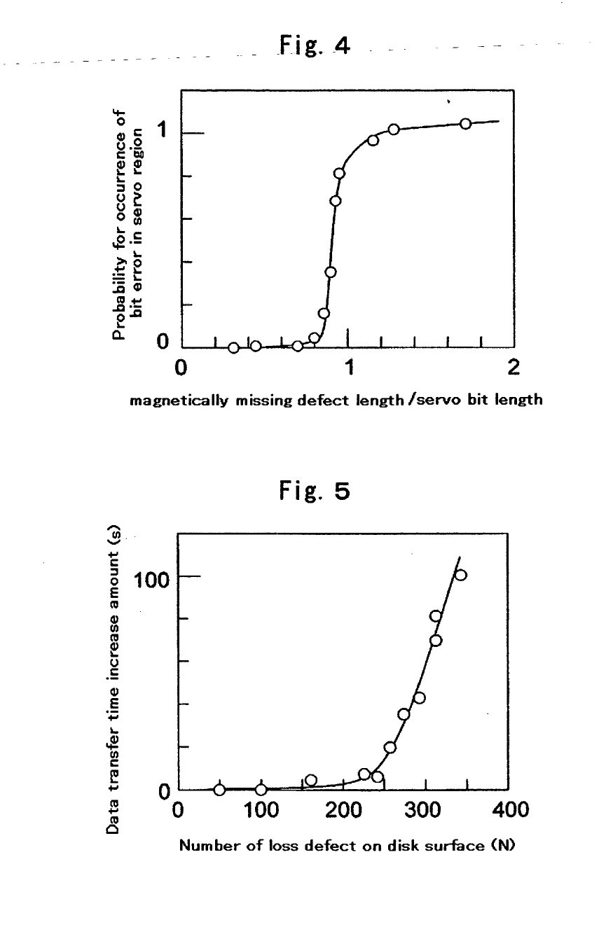

FIG. 4 shows a relationship between the size of the defect and the probability of occurrence of bit errors in the servo region when a vertical magnetic recording medium having various magnetic defects is assembled in a magnetic disk drive.

According to FIG. 4, it can be seen that the probability for the occurrence of the bit error in the servo region increases rapidly as the ratio of the length of the defect to the minimal bit length in the servo region (hereinafter referred to as servo bit length) is 0.9 or more.

FIG. 5 shows a relationship between the density of defects each having a length of 0.9 times or more the servo bit length and the data transfer time of the magnetic disk drive.

According to FIG. 5, an examination is made of the relationship between the number of defects present over the magnetic recording medium and the time necessary for reading out the data over the entire surface of the magnetic recording medium was examined. It reveals that the amount of increase of the data transfer time increases rapidly (I/O performance was degraded) in a case where the density of the defects having the length of 0.9 times or more the servo bit length exceeds 0.1 N/mm². In view of the above, it is probable that the defect on the vertical magnetic recording medium having the length of 0.9 times or more of the servo bit length causes deterioration of the I/O performance of the magnetic disk drive.

The length Ld of the defect is determined as: Ld=Pw×V, using the half-value width full width of half maximum Pw for the pulsative output as shown in FIG. 2 and a relative speed V between a medium and a head. As a result of analysis, it was found that a defect of a length 0.9 times or more the minimum bit length of the servo is recognized erroneously and a smaller length gives less effect. The magnetic defect density can be measured by the following method.

At first, a magnetic disk is magnetized in one direction vertical to a disk surface by a fixed magnet or the like. Then, a reading head is caused to run to scan the entire surface of the magnetic disk, an output waveform from the head obtained by an amplifier in a region identical with the servo is analyzed and the pulse waveforms of 0.9 times or more the servo bit length are counted at ½ for an average output as a threshold value.

Actually, control for restricting the number of magnetic defects to a prescribed number or less includes the following method.

At first, it is necessary to remove previously a portion that may cause a magnetic defect from the stage of a magnetic disk substrate. A magnetic layer with a flying height or more formed on a sharp protrusion on the surface of the substrate is removed by the subsequent cleaning step or the flying height test step for the magnetic head, resulting in a magnetic defect. In this case, when the radial width of the protrusion is a track width or more, it forms such a magnetic defect as reducing the reproduced output to zero. Accordingly, when grinding is conducted at an extremely fine pitch in the radial direction, substantial width of the protrusion can be decreased. On the other hand, if the protrusion has a certain length or more in the circumferential direction, this causes hindrance to flying as a mound, which can be rejected as a failed product by the test for the flying property. Actually, a pointed peak of 1 μm or less in the circumferential direction causes a magnetic defect in question.

In addition, magnetic defects are caused by dusts deposited on the surface of the substrate, unevenness caused by abnormal growth or dusting in the film forming step, scratches caused by insufficiency of mechanical strength of films, etc.

In this embodiment, the magnetic recording medium is formed by providing a soft magnetic backing layer anti-ferromagnetically coupled directly or by way of an adhesion layer after cleaning and drying of a non-magnetic substrate and, further, providing a granular magnetic layer and a protective layer by way of a crystal orientation control layer. The layers can be formed by sputtering using a target of an alloy material of a necessary composition. Further, the protective layer can also be formed by using a plasma chemical vapor deposition method in an atmosphere containing a hydrocarbon gas. A lubricant layer comprising, for example, a polymer having a perfluoro polyether main chain on the uppermost surface of the magnetic disk.

Since the thus prepared magnetic disk usually has defects in the form of protrusions due to the shape of the substrate, dusts left on the surface thereof, dusts deposited in the sputtering atmosphere, etc., the magnetic head cannot be caused to fly stably. Accordingly, a step of cleaning operation for the surface is often applied. In this step, also the film ingredients are sometimes destroyed and removed, and the portions remain as magnetic defects on the surface of the magnetic disk. By controlling specified magnetic defects among them, the performance of the magnetic disk can be improved.

The magnetic disk substrate is important since it has an influence on the surface shape of the magnetic disk and most affects surface defects. In this embodiment, reinforced glass, crystallized glass, NiP plated aluminum magnesium alloy, silicon, hard plastic, etc. can be used as the material. However, it is necessary to apply precise polishing to the surface for any of the materials. Since fine protrusions present on the magnetic disk substrate are transferred as they are or being further emphasized on a film formed thereon, they remain finally as local protrusions. The magnetic head has to be hovered at a predetermined flying height; therefore, the magnetic disk to be used is usually subjected to a surface cleaning step after film formation, and subjected to a tape cleaning step for surface fabrication by a polishing tape and/or head varnishing step of removing protrusions and deposits by a grinding head and then handed over a final inspection. In this case, magnetic recording layer is sometimes lacked after the removal of protrusions or deposits. In addition, in the case, it is important to restrict, among the lacked portions, those of a predetermined degree to less than the predetermined number. The deposits can be removed by the cleaning step and can be decreased by preventing contamination in the step before film formation. Accordingly, with at least the substrates, it is necessary to use the substrates in which such portions as causing defects described above are reduced.

In this embodiment, the adhesion layer, the soft magnetic backing layer, the crystal orientation control layer, the granular magnetic layer, the protective layer, and the lubrication layer are not particularly restricted. Since the frequency of the defect of the magnetic recording layer in the tape cleaning step or the head varnishing step is changed depending on the material and the film thickness, however, it will be needless to say that materials should be selected considering them.

In this embodiment, the surface of a glass substrate for use in a magnetic disk of 65 mm in outer diameter, 20 mm in inner diameter and 0.625 mm in thickness to an average roughness of 0.5 nm or less was mirror-polished. Ten positions were then selected at random for the surface of the substrate. A portion of 1 μm² was measured by an atomic force microscope to calculate the density of protrusions with a height of 5 nm or more from the average surface. Then, the substrate was attached to a spindle and rotated, to which a polishing cloth was pressed under a predetermined load while a polishing solution is dripped in which diamond abrasive grains with an average grain size of 0.3 μm was dispersed to the surface of the rotating substrate. In this state, the spindle was reciprocated in the radial direction to polish the entire surface of the substrate. Then, the remaining ingredient of the processing liquid was removed by a detergent from the substrate surface and the surface was washed with purified water and dried. A plurality of substrates each having the surface roughness shown in Table 1 were prepared while the polishing time and the pressing load upon chemical polishing are controlled. Several sheets of the substrates were extracted every one condition and the surface was measured by the atomic force microscope by the same method as before polishing. Thus, the average density of protrusions with a height of 5 nm or more is calculated.

The surfaces of the various kinds of substrates described above were cleaned with purified water for removing contamination and dried. The substrates were each introduced into a vacuum processing apparatus, on which an amorphous alloy under layer, a CoTaZr soft magnetic layer, a Ru layer, a CoCrPt—SiO₂ magnetic layer and a carbon protective film were formed successively. The substrate was taken out from the vacuum processing apparatus and a lubricant of perfluoro ether having OH groups on both terminal ends was applied to a thickness of about 10 nm. Then, the magnetic disk was attached to a spindle rotating at 2000 rpm, a polishing tape on which alumina abrasion grains were fixed by a binder was pressed under a predetermined load on both surfaces of a magnetic disk to remove dusts deposited on the surface. A magnetic disk thus prepared was fit into a spindle for a tester used exclusively for the magnetic disk and magnetic heads were attached to both surfaces and set up so as to enable signal reading/writing. A magnetic field is applied to the entire surface of the magnetic disk in a direction vertical thereto so as to align the direction of the magnetization. Then, the disk was rotated and the magnetic head was loaded, and signals were reproduced on every movement by track width in the radial direction. The reproduced signal was processed by a waveform analyzer and peaks of a length of 0.09 μm or more at a threshold value ½ for the average output were counted. A servo signal of 0.1 μm bit length is written to the magnetic disk prepared as described above. Then, the disk was assembled into a disk drive casing for 2.5 inch, and a magnetic head assembly for reading/writing was attached to the casing to thus assemble a magnetic disk drive.

The magnetic disk drive was driven, a track was specified at random and an average seek time from the processing of an instruction to transfer the magnetic head to the track till completion thereof was measured.

TABLE 1

| | Square mean | Density of | Number of | Average |
|---|---|---|---|---|
| | average | protrusion of | regenerated signal | sequence |
| | roughness | 5 nm or more | zero points | time |
| Sample | (nm) | (N/mm²) | Number | msec |
| Disk 1 | 0.17 | 0.02 | 2 | 11.5 |
| Disk 2 | 0.14 | 0.05 | 15 | 11.5 |
| Disk 3 | 0.33 | 0.08 | 120 | 11.5 |

Table 1 shows the measurements including the average density of protrusions, number of counts for the reproduced signal zero points and the average value of the average seek time for the respective magnetic disks and magnetic disk drive.

In this embodiment, substrates of characteristics as shown in Table 2 were provided while the polishing conditions were changed.

TABLE 2

| | Square mean | Density of | Number of | Average |
|---|---|---|---|---|
| | average | protrusion of | regenerated signal | sequence |
| | roughness | 5 nm or more | zero points | time |
| Sample | (nm) | (N/mm²) | Number | msec |
| Disk 4 | 0.55 | 5.5 | 2800 | NG |
| Disk 5 | 0.33 | 0.2 | 360 | 12.8 |
| Disk 6 | 0.14 | 0.35 | 670 | 13.5 |

For the substrates, magnetic disks were prepared by way of identical steps and they were evaluated in the same manner. As a result, as shown in Table 2, the number of counts for the reproduced signal zero is more as the average density of protrusion is increased. The servo operation itself is failed for those of longer or extreme seek time.

A substrate of the same specification as the magnetic disk 5 shown in Table 2 was used and a step of immersing for 60 sec in an aqueous alkali solution containing KOH at pH of about 12 before cleaning with purified water was added to the cleaning step before film formation. Table 3 shows the measurements of the surface of the substrate by an atomic force microscope. A magnetic disk was prepared by using the substrate and the disk was evaluated in the same manner. The defect density of reducing the reproduced signal to zero was decreased as shown in Table 3 and delay in the servo operation was not observed.

TABLE 3

| | Square mean | Density of | Number of | Average |
|---|---|---|---|---|
| | average | protrusion of | regenerated signal | sequence |
| | roughness | 5 nm or more | zero points | time |
| Sample | (nm) | (N/mm²) | Number | msec |
| Disk 7 | 0.31 | 0.07 | 108 | 11.5 |

As described above, in this embodiment, by restricting the density of defects having a length of 0.9 times or more the servo bit length on the vertical magnetic recording medium to about 0.1 N/mm⁻² or less, it is possible not to increase the data transfer time in a case of reading data for the entire surface of the vertical magnetic recording medium. Accordingly, a vertical magnetic recording medium of high I/O performance and a magnetic disk drive using the same are attained.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A method of manufacturing a magnetic disk for vertical magnetic recording by cleaning a non-magnetic substrate and then providing a soft magnetic backing layer, a non-magnetic intermediate layer, a vertical orientation magnetic film, a protective film, and a lubrication layer successively to a surface of the non-magnetic substrate directly or by way of a metal alloy layer, the method comprising:
applying a magnetic field to an entire surface of a magnetic disk in a direction vertical thereto;
rotating the magnetic disk, loading a magnetic head to the magnetic disk and reproducing signals from the magnetic disk; and
processing the reproduced signals by a waveform analyzer and counting pulse waveforms of 0.9 times or more a servo-bit length at ½ threshold value of an average output.

2. A method of manufacturing a magnetic disk according to claim 1, wherein the signals are reproduced from the magnetic disk every time the magnetic head is moved on a track width basis in a radial direction of the magnetic disk.

3. A method of manufacturing a magnetic disk according to claim 1, wherein signals obtained by an amplifier of a region identical with signals of servo and reproduced by the magnetic head is processed by a waveform analyzer.

4. A method of manufacturing a magnetic disk according to claim 1, wherein the non-magnetic substrate is made of a material selected from the group consisting of reinforced glass, crystallized glass, NiP plated aluminum magnesium alloy, silicon, and hard plastic.

5. A method of manufacturing a magnetic disk according to claim 1, wherein the non-magnetic substrate has thereon an amorphous alloy under layer, a CoTaZr soft magnetic layer as the soft magnetic backing layer, a Ru layer as the non-magnetic intermediate layer, a CoCrPt—SiO₂ magnetic layer as the vertical orientation magnetic film, a carbon protective film as the protective film, and the lubrication layer.

6. A method of manufacturing a magnetic disk according to claim 1, wherein the non-magnetic substrate is cleaned with purified water.

7. A method of manufacturing a magnetic disk according to claim 6, wherein the non-magnetic substrate is immersed in an aqueous alkali solution containing KOH at pH of about 12 before being cleaned with purified water.

8. A method of manufacturing a magnetic disk according to claim 1, further comprising restricting a density of defects having a length of 0.9 times or more the servo bit length on the recording disk to about 0.1 N/mm ⁻² or less.

9. A magnetic disk for vertical magnetic recording, comprising a non-magnetic substrate, and a soft magnetic backing layer, a non-magnetic intermediate layer, a vertical orientation magnetic film, a protective film, and a lubrication layer successively provided on a surface of the non-magnetic substrate,
wherein a density of defects having a length of 0.9 times or more the servo bit length on the recording disk is restricted to about 0.1 N/mm ⁻² or less.

10. A magnetic disk for vertical magnetic recording according to claim 9, wherein the non-magnetic substrate is made of a material selected from the group consisting of reinforced glass, crystallized glass, NiP plated aluminum magnesium alloy, silicon, and hard plastic.

11. A magnetic disk for vertical magnetic recording according to claim 9, wherein the non-magnetic substrate has thereon an amorphous alloy under layer, and wherein the soft magnetic backing layer is formed on the amorphous alloy under layer.

12. A magnetic disk for vertical magnetic recording according to claim 9, wherein the soft magnetic backing layer comprises a CoTaZr soft magnetic layer.

13. A magnetic disk for vertical magnetic recording according to claim 9, wherein the non-magnetic intermediate layer comprises a Ru layer.

14. A magnetic disk for vertical magnetic recording according to claim 9, wherein the vertical orientation magnetic film comprises a CoCrPt—SiO₂ magnetic layer.

15. A magnetic disk for vertical magnetic recording according to claim 9, wherein the protective film comprises carbon.
